(19) United States
(12) Patent Application Publication
(10) Pub. No.: US 2022/0213352 A1
(43) Pub. Date: Jul. 7, 2022

(54) TRANSFER PRINTABLE ELASTIC DISPERSION WITH SOLID LOW MELT POWDER

(71) Applicant: The Lycra Company LLC, Wilmington, DE (US)

(72) Inventor: Tianyi LIAO, Chadds Ford, PA (US)

(21) Appl. No.: 17/609,652

(22) PCT Filed: May 8, 2020
(86) PCT No.: PCT/US2020/032005

§ 371 Date: Nov. 8, 2021

Related U.S. Application Data
(60) Provisional application No. 62/845,395, filed on May 9, 2019.

(51) Int. Cl. C09J 7/35; C09J 175/04; C09J 7/21; C09J 7/25; C08J 3/12

(52) U.S. Cl. CPC C09J 7/35; C09J 175/04; C09J 7/21; C09J 7/255; C09J 2477/00; C09J 2203/358; C09J 2301/304; C09J 2467/00; C09J 2475/00; C08J 3/12

(57) ABSTRACT

An elastic tape or film of a aqueous polyurethane dispersion with solid low melt powder which can be applied to a fabric via transfer printing as well as methods for production of the elastic tape or film, articles of manufacture comprising the elastic tape or film and methods for production of the elastic tape or film are provided.

### FIELD OF THE INVENTION

This disclosure relates to an elastic tape or film of an elastic polymer dispersion with solid low melt powder which can be applied to a fabric via transfer printing as well as methods for production of the elastic tape or film, articles of manufacture comprising the elastic tape or film and methods for production of the elastic tape or film.

### BACKGROUND OF THE INVENTION

Polyurethanes (including polyurethaneureas) can be used as adhesives for various substrates, including textile fabrics. Typically, such polyurethanes are either fully formed nonreactive polymers or reactive isocyanate-terminated prepolymers. Such reactive polyurethane adhesives often require extended curing time to develop adequate bonding strength, which can be a disadvantage in manufacturing processes. In addition, the isocyanate groups of the polyurethanes are known to be sensitive to moisture, which limits the storage stability and reduces the shelf life of the product incorporating such polyurethanes. Typically, such polymers, when fully formed, are either dissolved in a solvent (solvent borne), dispersed in water (waterborne), or processed as thermoplastic solid materials (hot melt). Notably, solvent-based adhesives face ever-tightening health and environmental legislation aimed at reducing volatile organic compound (VOC) and hazardous air pollutant (HAP) emissions. Accordingly, alternatives to conventional solvent-based products are needed.

Many attempts have been made to develop water borne polyurethane adhesives to overcome these deficiencies. Aqueous polyurethane dispersions (APD) may be useful materials for various applications, such as, for example, coatings, adhesives and sealants. See, for example, U.S. Pat. Nos. 6,248,415; 6,284,836; and 6,642,303; which are incorporated by reference herein. APD may also find utility in the preparation of film-based articles of manufacture, such as, for example, polyurethane gloves. See, for example, U.S. Pat. No. 7,045,573, which is incorporated by reference herein. APD are also relatively environmentally and physiologically friendly owing to a low or zero volatile organic compound (VOC) content, which may facilitate the use of APD in personal care products, such as, for example, hair fixatives and skin protection formulations. See, for example, U.S. Pat. Nos. 7,445,770 and 7,452,525, which are incorporated by reference herein.

Aqueous polyurethane dispersions have poor adhesive property when binding with substrate. Further, higher bonding temperature to bind with substrate material is required and the wash fastness of the binding needs to be improved.

Low Melt Powders (LMP) are one form of low melt adhesive, which are applied as a solid particle form. Under heat, LMP get molten, and then placed in contact with a substrate. The LMP cools and hardens to form a bond between the substrates. LMP are widely used for industrial adhesive applications such as product assembly and packaging. The latter include case and carton sealing. LMP, although environmentally safe and easily applied as powders or films, generally have high set and poor recovery when subject to repeated stretch cycles.

Therefore, a need still exists for APD incorporating LMP which exhibit good adhesive ability and bonding ability could active at very low temperature. The composite has not only excellent stretch and recovery performance but also excellent binding and easy applications.

### SUMMARY OF THE INVENTION

An aspect of the present invention relates to an elastic tape or film comprising an elastic polymer dispersion and a solid low melt powder. The solid low melt powder could be melt at temperature between 60° C. to 190° C.

An aspect of the present invention relates to an elastic tape or film comprising an elastic polymer dispersion and a solid low melt powder. The solid low melt powder is mainly located in one side of the film or the tape. The film and tape exhibit excellent elasticity, recovery power and good binding ability.

An aspect of the present invention relates to an elastic tape or film comprising an elastic polymer dispersion and a solid low melt powder. The solid low melt powder could be melt away and keep empty pores inside the film. The film and tape have good air perm ability.

An aspect of the present invention relates to an elastic tape or film comprising an elastic substrate and an elastic polymer dispersion with a solid low melt powder. In some nonlimiting embodiment, the substrate is an elastic film or elastic fabric.

Another aspect of the present invention relates to an article of manufacture at least a portion of which comprises an elastic tape or film comprising a polymer dispersion and a solid low melt powder applied to the article of manufacture via transfer printing. In one nonlimiting embodiment, the article of manufacture is a garment.

Another aspect of the present invention relates to a method for producing an transfer printable elastic tape or film, said method comprising evenly distributing a solid low melt powder in a polymer dispersion through a powder spread or powder mixture print.

Yet another aspect of the present invention relates to a method for production of an article of manufacture wherein an elastic tape or file comprising a polymer dispersion and a solid low melt powder is applied to the article of manufacture via transfer printing. The transfer printing can be performed through a heat plate or iron-on. The article has dimension stability, strength enhancing or shaping functions.

### BRIEF DESCRIPTION OF THE FIGURES

FIG. 1 is a schematic diagram of a fabric bonded with an elastic film comprising a polymer dispersion and a solid low melt powder.

FIG. 2, views A, B and C are schematic diagrams of an elastic film comprising a polymer dispersion and a solid low melt powder wherein view A depicts a low melt powder mixed evenly within the dispersion and film, view B depicts a low melt powder located in one side of the dispersion and film, and view C depicts a low melt powder located in two sides of the dispersion and film.

FIG. 3 is a schematic diagram depicting two layers of fabrics bonded with an elastic film comprising a polymer dispersion and a solid low melt powder.

FIG. 4 is a photograph of a film with empty pores after melting down of low melt powder within the dispersion polymer.

FIG. 5 is a flowchart showing the processing steps that may be used to an elastic film comprising a polymer dispersion and a solid low melt powder via mixture solution.

FIG. 6 is a flowchart showing a nonlimiting embodiment of processing steps that can be used to produce an elastic film comprising a polymer dispersion and a solid low melt powder with elastic substrate.

FIG. 7 is a flowchart showing a nonlimiting embodiment of processing steps that can be used to produce an elastic film comprising a polymer dispersion and a solid low melt powder with direct application of powder.

FIG. 8 is a photograph of a garment, namely pants, with elastic film shaping areas arranged around the buttock area and thigh area.

FIG. 9 is a photograph of a garment, namely a shirt, with elastic film shaping areas in front of the wearer's body.

FIG. 10 is a photograph of a garment, namely a bra, with elastic film shaping areas in front of body arranged in the wearer's bra.

### DETAILED DESCRIPTION OF THE INVENTION

This invention relates to an elastic tape or film comprising an aqueous polyurethane dispersion with solid low melt powder which can be applied to an article of manufacture such as, but not limited to a fabric or garment via transfer printing.

As used herein, the term “film” means a flat, generally two-dimensional article. The film may be self-supporting such as a film that has been cast and dried or extruded. Alternatively, the film may be a melt, dispersion or solution.

As used herein, the term “pressing” or “pressed” refers to an article that has been subjected to heat and/or pressure to provide a substantially planar structure.

As used herein, the term “heat transfer” or “heat transfer printing” refers to a method that applies custom designs to items like t-shirts or sport wear through a process that uses a combination of heat and pressure. Common kinds of heat transfer printing include, but are not limited to, film heat transfer and digital print heat transfer. With the heat transfer process, a machine is used to cut out designs and letters in pieces of film. A heat press is then used to transfer the shape and colors of the design onto the object being printed. This type of film allows the design to be transferred from the paper to the item being printed when pressed with heat. A heat press machine is needed to transfer the graphic, either film or printed, from one surface to another. It is the combined effects of heat and pressure that transfer the design.

As used herein, the term “dispersion” refers to a system in which the disperse phase consists of finely divided particles, and the continuous phase can be a liquid, solid or gas.

As used herein, the term “aqueous polyurethane dispersion” refers to a composition containing at least a polyurethane or polyurethane urea polymer or prepolymer, optionally including a solvent, that has been dispersed in an aqueous medium, such as water, including de-ionized water. In one nonlimiting embodiment, the dispersion comprises a polyurethane prepolymer as described herein.

As used herein, the term “solvent,” unless otherwise indicated, refers to a non-aqueous medium, wherein the non-aqueous medium includes organic solvents, including volatile organic solvents and somewhat less volatile organic solvents. A nonlimiting example of a volatile organic solvent is acetone. Nonlimiting examples of somewhat less volatile organic solvents include methyl ethyl ketone (MEK) and N-methyl-2-pyrrolidone (NMP).

As used herein, the term “solvent-free” or “solvent-free system” refers to a composition or dispersion wherein the bulk of the composition or dispersed components has not been dissolved or dispersed in a solvent.

As used herein, the term “low melt powder” refers to polymer-based materials in small size particles which are thermoplastic in nature. Low melt powders are solid at room temperature. Under heat, the solid particles transfer into liquid or molten form, and bind with other materials. The molten form which may comprise a film or a series of beads is converted to a solid form when the material cools and sets. Low melt powders are commonly used for case and carton sealing and assembly, container labeling, and paper converting. Because low melt powders do not utilize water or solvents, they have a very fast set time thus making them a more popular kind of industrial adhesive.

As used herein, the term “fabric” refers to a knitted, woven or nonwoven material. Nonlimiting examples of knitted fabric include flat knit, circular knit, warp knit, narrow elastic and lace. Woven fabric may be of any construction and nonlimiting examples include sateen, twill, plain weave, oxford weave, basket weave, and narrow elastic. Nonlimiting examples of nonwoven material include melt blown, spun bonded, wet-laid, carded fiber-based staple webs, and the like.

As used herein, the term “hard yarn” refers to a yarn which is substantially non-elastic.

As used herein, the term “derived from” refers to forming a substance out of another object. For example, a film may be derived from a dispersion which can be dried.

Elastomeric fibers are commonly used to provide stretch and elastic recovery in fabrics and garments. “Elastomeric fibers” are either a continuous filament, optionally a coalesced multifilament, or a plurality of filaments, free of diluents, which have a break elongation in excess of 100% independent of any crimp. An elastomeric fiber when (1) stretched to twice its length; (2) held for one minute; and (3) released, retracts to less than 1.5 times its original length within one minute of being released. As used in the text of this specification, “elastomeric fibers” means at least one elastomeric fiber or filament. Such elastomeric fibers include but are not limited to, rubber filament, biconstituent filament comprising rubber, polyurethane, etc., lastol and spandex. The terms “elastomeric” and “elastic” are used interchangeably throughout the specification.

“Spandex” is a manufactured filament in which the filament-forming substance is a long chain synthetic polymer comprised of at least 85% by weight of segmented polyurethane.

“Elastoester” is a manufactured filament in which the fiber forming substance is a long chain synthetic polymer composed of at least 50% by weight of aliphatic polyether and at least 35% by weight of polyester. Although not elastomeric, elastoester may be included in some fabrics herein.

“Polyester bi-component filament” means a continuous filament comprising a pair of polyesters intimately adhered to each other along the length of the fiber, so that the fiber cross section is, for example, a side-by-side, eccentric sheath-core or other suitable cross-section from which useful crimp can be developed. The polyester bicomponent filament comprises poly(trimethylene terephthalate) and at least one polymer selected from the group consisting of poly(ethylene terephthalate), poly(trimethylene terephthalate), and poly(tetramethylene terephthalate) or a combination of such members, having an after heat-set crimp contraction value of from about 10% to about 80%.

In accordance with an aspect of the present invention, low melt powder is mixed with liquid polyurethane dispersion. The solid low melt powder is mixed and distributed in the liquid dispersion, which can dramatically increase the bond ability of dispersion or film with the substrate fabric. As a result, such film or tape can provide excellent stretch, recovery and easy bonding with the fabric by pressing heat. The film can be applied on some garments for decorating or shaping purpose.

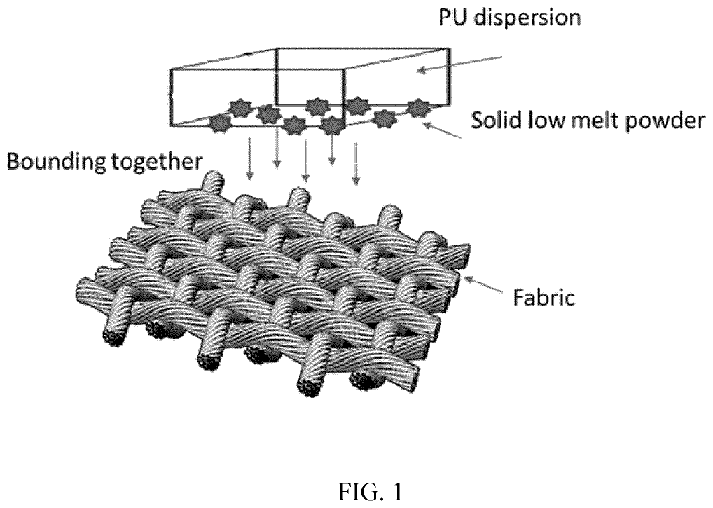

As illustrated in FIG. 1, low melt powder (LMP) is blended with aqueous polyurethane dispersion (APD). Since the dispersion is aqueous based, solid LMP with small size evenly distributes among the dispersion to form the dispersion mixture. In this nonlimiting embodiment of the present invention, the LMP is dispersed in water. APD is used as a thickener. The dispersion provides a product having uniform quality. One of the objectives of this invention is to provide a mixture of APD with LMP in which the sedimentation of LMP is effectively prevented and a product having uniform quality by using the mixture is produced. A desirable method to prepare the mixture is a method in which a LMP is dispersed with the APD. Stirring is necessary to get even blended.

The dispersion mixture can be cast or printed on a release paper. During drying, the water evaporates and the dispersion mixture becomes a film. Polyurethane polymers connect together to form an elastic entity in the form of film or tape, which provide good elasticity and excellent recovery. The LMP exists in the surface of the film and contacts with the substrate fabric under press. When the film is heated, the LMP melts and adheres with the substrate fabric. After cooling down, the film firmly bond with the fabric.

The resulting film of the present invention can be used on certain fabrics and materials to create designs and promotional products. It also can be used to enhance certain parts of garments with high recovery power or elasticity for shaping or support purposes. The film can be casted in a roll or sheet form, so it can be cut, weeded, and placed on a fabric for heat application. Alternatively, it can be printed with selected print patterns and/or shapes. The film can be made in single colors or may be patterned, glittered, flocked, holographic, glow-in-the-dark, reflective and/or 3-dimensional puff.

A heat press machine can be used to transfer the film, tape or print onto fabric. The machine is engineered to imprint a design or graphic on a substrate, such as a T-shirt, with the application of heat and pressure for a preset period of time. While heat presses are often used to apply designs to fabrics, specially designed presses can also be used to imprint designs on alternative substrates such as mugs, plates, jigsaw puzzles, caps, and other products.

LMP can be melted and provide binding ability at very low temperatures in the short period. This easy binding character makes the transfer print manufacture process convenient. The ability to use low temperatures is helpful in reducing heat damage to fabric performance and color change. Heat press with low temperature and short time prevents elasticity and power loss in stretch fabric.

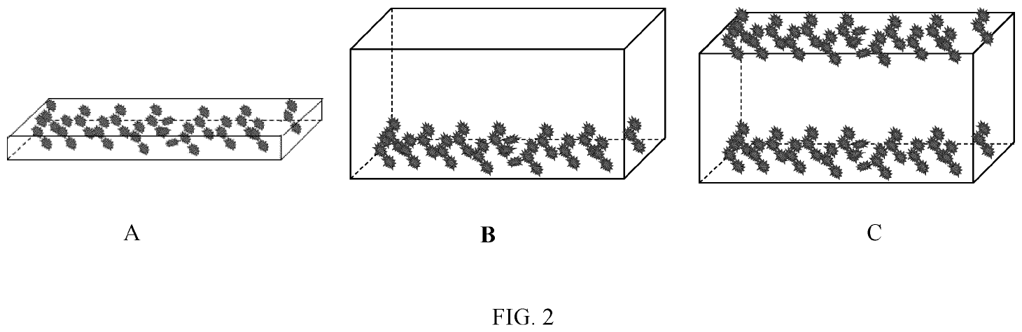

In accordance with another aspect of the present invention, the solid LMP can be distributed evenly within the entire film (see FIG. 2, view A), mainly located in one side of the film (see FIG. 2, view B), or mainly located in both sides of the film, face and back side (see FIG. 2, view C).

The elastic recovery ability of the film is affected by the amount of LMP added into the dispersion. High amounts of LMP in the dispersion can reduce the break tenacity, break elongation and recovery power. It can also increase the unrecoverable portion of the film, also referred to as high set. In contrast, if the dispersion has low content of LMP, the film may exhibit poor binding ability. FIG. 2, view B provides a nonlimiting example of a way to maintain film with both good elasticity and excellent binding performance. The LMP is placed in the back side of the film to offer easy and strong binding, while the front or surface side of the film is made up of pure APD polymer, thus providing excellent elasticity and recovery power.

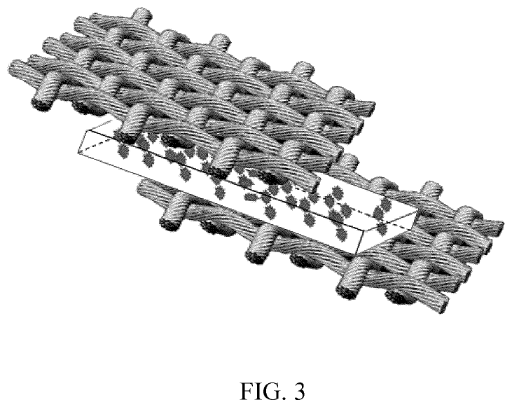

As shown in FIG. 2, view C, LMP can also be included in both sides of the film, surface and back, while the center portion of the film is 100% APD. The film possesses excellent elasticity while also have good binding ability in both sides of the film. One application for this film is to bind two pieces of fabrics together, as demonstrated in FIG. 3. This nonlimiting embodiment of film works well as the core of a sandwich structure between two substrates.

In accordance with a third aspect of the present invention, an elastic tape or film is provided which has good air permeability. In this nonlimiting embodiment, the film comprises an APD and a solid LPM. The solid LMP can be melted away, thereby leaving empty pores inside the film.

Surprising, the inventors herein have found that there is a complex mixture of microscopic pores in micron units in the film of the present invention which are left behind after some types of low melt powder have melted out. Thus, in some embodiments of this invention, the film is a porous film, featuring hundreds of little holes that cannot be detected by the naked eye. In these structures, water and wind will not pass through, while air and moisture vapor do. Thus, these films of the present invention truly breathe. The films of the present invention combine all of the functions of good elasticity, excellent binding performance and breathability into one material. These capabilities are useful not only in garments but also in the adhesive heating pad industry, which requires highly-efficient ventilation and stability.

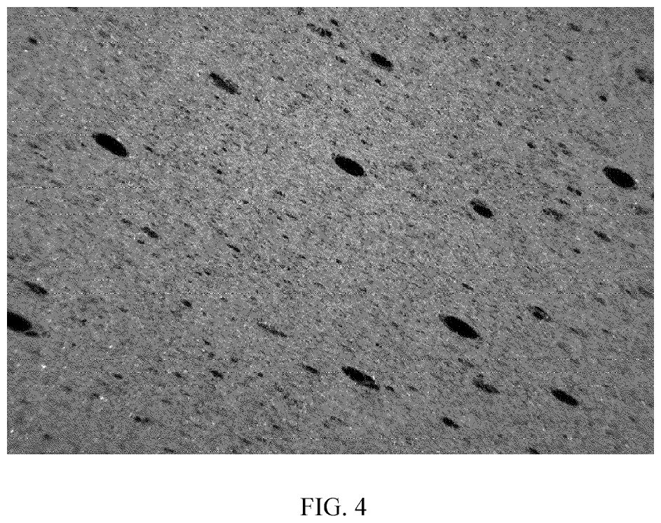

FIG. 4 is a photograph of a film of this embodiment showing the empty pores created when the original solid LMP melts out. The empty pores are so small that liquid water cannot go through. However, vapor water molecules are many times smaller than the liquid state and can pass through these micro pores.

In accordance with fourth aspect of the present invention, a method is provided for producing a transfer printable elastic tape or film. The method comprises evenly distributing a solid LMP in an aqueous dispersion, or evenly spreading dry solid powder on the APD mixture or dry film.

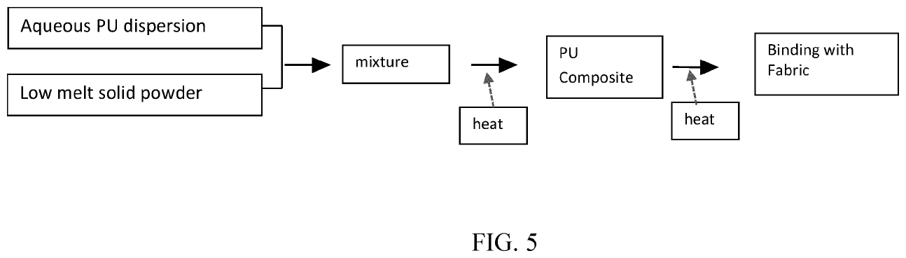

In one nonlimiting embodiment of the present invention, the heat transfer films or tapes are made by coating the dispersion mixture onto a release paper. The coated release paper is then dried at temperatures below about 100° C. to remove water and form a film on the paper. There are known commercially available processes for drying at temperature below about 100° C. FIG. 5 provides a flowchart of this process.

The formed film sheets can be slit into strips of desired width and wound-up into spools for later use in applications to form stretch articles, for example textile fabrics. Nonlimiting examples of such applications include: stitch-less or seamless garment constructions; seam seal and reinforcement; labels and patches bonding to garments; and localized stretch/recovery enhancement.

Through heat transfer process, the adhesion bonding of these films can be developed in the temperature range of from about 100° C. to about 200° C., such as from about 130° C. to about 200° C., for example, from about 140° C. to about 180° C., in a period of seconds to minutes, for example, less than about one minute. This bonding is expected to be strong and durable when exposed to repeated wear, wash, and stretch in a textile fabric garment. Heat pressing can be carried out to secure the film to a fabric using any method wherein heat is applied to the film surface.

The APDs with LMP of the present invention are particularly suitable for adhesive films or tapes used for fabric bonding, lamination, and adhesion purposes when applied with heat and pressure for a relatively short period of time. Pressures can range, for example, from about atmospheric pressure to about 60 psi. Times can range from less than about one second to about 30 minutes in accordance with the bonding method used.

The method of the present invention is not only able to make heat transfer film as shown in FIG. 2, view A, but is also able to make air breathable films as shown in FIG. 4. The process for making the breathable film comprises blend the APD with LMP at predetermined ratio, stirring the LPM evenly into APD mixture, casting the resulting mixture on the surface of release paper, drying the mixture into film, and stretching the film to generate the micro pores if necessary. For better breather ability, the temperature for drying the mixture is higher than the melt temperature of the LMD.

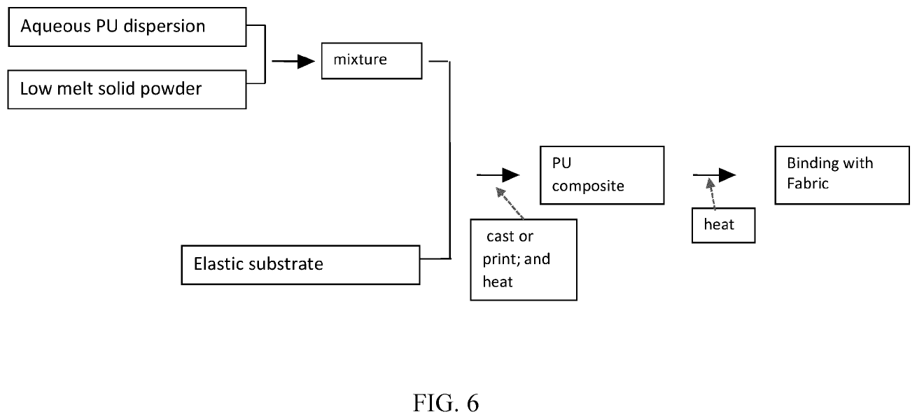

In another nonlimiting embodiment of the present invention, the heat transfer films or tapes with dispersion composite structure are made by coating the dispersion mixture onto an elastic reinforcement such as elastic film, fabrics or other substrates. As depicted in FIG. 6, after blending dispersion and LMP together, the dispersion mixture is applied on the surface of the elastic reinforcement. During the drying process, the dispersion mixture binds with the elastic reinforcement to form an elastic dispersion composite.

Within the elastic dispersion composite structure, the elastic reinforcement can provide extra elastic power to the film. It can also introduce additional functions and performance to the film such as, but not limited to, higher modulus, break strength, better durability, surface texture, improved synthetic and rubber touch and appearance. For example, if elastic film is used as reinforcement, the aqueous polyurethane dispersion will melt together with the reinforce film and the two films will work together to offer stretch and recovery. The composite becomes very powerful and robotic. At the same time, the LMP locates in one side of the film, where the mixture is applied. The dispersion composite can also bind with another substrate fabric through this LMP. As another example, if an elastic knit fabric is used as reinforcement, the APD and LMP mixture is applied on one side of the reinforcement. This dispersion composite can create knit fabric surfaces when bond with other substrate fabrics.

The methods that can be used to apply dispersions mixture falling within the scope of the present invention on an article include, but are not limited to: roll coating, reverse roll coating; use of a metal tool or knife blade; spraying; dipping; painting; printing; stamping; and impregnating the article. In one nonlimiting embodiment, use of a metal tool or knit blade involves pouring a dispersion onto a substrate and then casting the dispersion mixture into uniform thickness by spreading it across the substrate using the metal tool or knife blade. In one nonlimiting embodiment, spraying invoices use of a pump spray bottle. These methods can be used to apply the dispersion mixture directly onto a substrate without the need of further adhesive materials and can be repeated if additional/heavier layers are required. The dispersions can be applied to any fabrics of knits, wovens or nonwovens made from synthetic, natural, or synthetic/natural blended materials for coating, bonding, lamination and adhesion purposes. The water in the dispersion can be eliminated with drying during the processing, leaving the precipitated and coalesced polyurethane layer with low melt powder on the fabrics to form an adhesive bond. In some nonlimiting embodiments, drying is performed, via air drying or oven-drying.

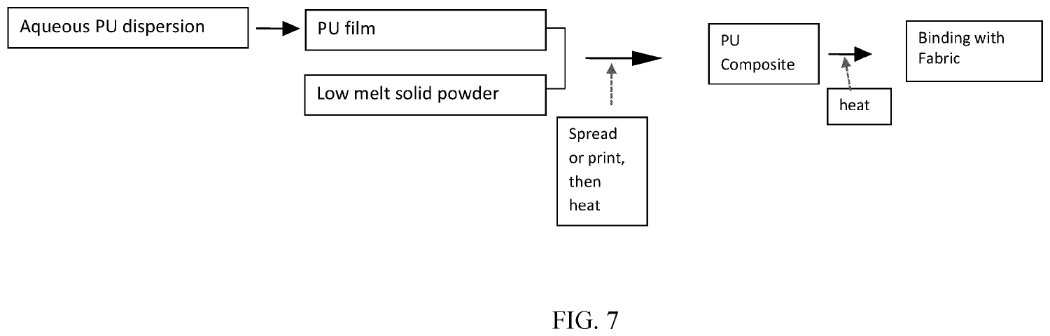

In another nonlimiting embodiment of the present invention, the solid powder is applied on the wet aqueous polyurethane dispersion or dry film of APD, as shown in FIG. 7. In this nonlimiting embodiment, the manufacture process comprises casting or printing the APD on release paper or a substrate with desirable designs. Under wet or dry state, LMP is then spread on to the film or print, while ensuring that the solid LMP covers the surface of the dispersion. Any extra LMP is taken away from the paper or substrate. The paper or substrate with the APD and LMP is then heated and dried at a temperature lower than 100° C. The resulting composite is then ready to be used for thermal transfer applications on fabrics and other substrates.

In one nonlimiting embodiment, the method comprises a screen print plus LMP spread method. In the method, the design with APD is screen processed on release paper. The release paper is then dipped into the low melt powder and tilted so that the LMP covers all of the dispersion. Any excess LMP is then shaken off and the resulting transfer print is placed onto an oven belt at temperature recommended by dispersion makers. When the transfer comes out of the oven, it is ready to be used or stored.

Depending on the desired effect of the polyurethane composition of some embodiments when applied as a dispersion from the aqueous dispersion described herein, the weight average molecular weight of the polymer may vary from about 40,000 to about 150,000, including from about 100,000 to about 150,000 and about 120,000 to about 140,000.

Polyurethane aqueous dispersions useful in some aspects should be expected to have a solids content of from about 10% to about 50% by weight, for example from about 30% to about 55% by weight. The viscosity of polyurethane aqueous dispersions useful in some aspects may be varied in a broad range from about 10 centipoises to about 100,000 centipoises depending on the processing and application requirements. For example, in one embodiment, the viscosity is in the range of about 500 centipoises to about 30,000 centipoises. The viscosity may be varied by using an appropriate amount of thickening agent, such as from about 0 to about 2.0 wt %, based on the total weight of the aqueous dispersion.

An organic solvent may also be used in the preparation dispersions of some embodiments. The organic solvent may be used to lower the prepolymer viscosity through dissolution and dilution and/or to assist in the dispersion of solid particles of the diol compound having a carboxylic acid group such as 2,2-dimethylopropionic acid (DMPA) to enhance the dispersion quality. It may also serve for the purposes to improve the uniformity.

Solvents selected for these purposes are substantially or completely non-reactive to isocyanate groups, stable in water, and have a good solubilizing ability for DMPA, the formed salt of DMPA and triethylamine, and the prepolymer. Examples of suitable solvents include N-methylpyrrolidone, N-ethylpyrrolidone, dipropylene glycol dimethyl ether, propylene glycol n-butyl ether acetate, N,N-dimethylacetamide, N,N-dimethylformamide, 2-propanone (acetone) and 2-butanone (methylethylketone or MEK).

The amount of solvent added to the dispersion of some embodiments may vary. When a solvent is added, suitable ranges of solvent include amounts of less than 50% by weight of the dispersion. Smaller amounts may also be used such as less than 20% by weight of the dispersion, less than 10% by weight of the dispersion, less than 5% by weight of the dispersion and less than 3% by weight of the dispersion.

There are many ways to incorporate the organic solvent into the dispersion at different stages of the manufacturing process.

In one nonlimiting embodiment, the solvent is added to and mixed with the prepolymer after the polymerization is completed but prior to transferring and dispersing the prepolymer. In this nonlimiting embodiment, the diluted prepolymer containing the carboxylic acid groups in the backbone and isocyanate groups at the chain ends are neutralized and chain extended while dispersed in water.

In another nonlimiting embodiment, the solvent is added and mixed with other ingredients such as Terathane® 1800, DMPA and Lupranate® MI to make a prepolymer in the solution. This prepolymer containing the carboxylic acid groups in the backbone and isocyanate groups at the chain ends in the solution is then added and dispersed in water while at the same time being neutralized and chain extended.

In another nonlimiting embodiment, the solvent is added with the neutralized salt of DMPA and Triethylamine (TEA), and mixed with Terathane® 1800 and Lupranate® MI to make the prepolymer prior to dispersion.

In another nonlimiting embodiment, the solvent is mixed with TEA, and then added to the formed prepolymer prior to dispersion.

In another nonlimiting embodiment, the solvent is added and mixed with the glycol, followed by the addition of DMPA, TEA and then Lupranate® MI in sequence to a neutralized prepolymer in solution prior to dispersion.

For textiles, LMP can be selected from polyester, polyester copolymers, polyamide, polyamide copolymer, polypropylene, polyolefin, polyurethane, ethylene-vinyl acetate (EVA), metallocene and the like. They may be used singly or as a mixture of two or more kinds.

These adhesives set quickly and offer strong resistance properties and operate in a moderate range of temperatures.

In one nonlimiting embodiment, the LMP comprises EVA which has a wide range of formulation and work well with substrates comprising paper or cellulosic materials.

In one nonlimiting embodiment, the LMP comprises polyolefin made with a catalyzed metallocene base. This LMP has excellent adhesive qualities and an even faster set speed. It is also extremely resistant and services a vast range of temperatures. These adhesives are also used in the packaging, converting, and assembly industries, but are limited in their range of available formulations.

In one nonlimiting embodiment, the LMP comprises polyester copolymers. These LMPs have good laundering resistance, good specific bonding performance to a variety of substrates, adjustable flexibility, good flame resistance and very good ecological properties as they have no volatile components and are recyclable.

In one nonlimiting embodiment, the LMP comprises polyamide copolymers. These LMPs also have good laundering resistance as well as very good dry-cleaning resistance, good specific bonding performance, good transparency, good hydrolysis resistance, and good organic solvent resistance.

The article size of the LMP is usually in the range between 1 um to 50 um.

For screen print, the screen print mesh is between 50 to 300 Mesh.

The advantages to using LMP are that they have a very fast set speed and feature moderate resistance properties. Depending on the formulation being used, they also are also applicable in a wide range of temperatures and industries and feature excellent adhesive qualities. However, alone they have poor elasticity and recovery power.

When LMP is dispersed in APD in accordance with the present invention, LMP weight is about 1% to 95% of the weight of APD. The melt temperature of LMP is in the range from 60° C. to 190° C.

In accordance with a fifth aspect of the present invention, there is provided a method for production of an article of manufacture wherein an elastic tape or file comprising an APD and a solid LMP is applied to the article of manufacture via transfer printing. The transfer printing can be performed through a heat plate or iron-on. The article has dimension stability, strength enhancing or shaping functions.

The transfer film can be placed on various fabrics or garments, such as, but not limited to, polo shirts, T-shirts, hats, sweat pants, jeans, denim jeans, purses, jackets, ties, blankets, scarves, active wear, intimate wear, sportswear, professional apparel, intimate apparel and ready to wear.

In one nonlimiting embodiment, the elastic tape or film is applied to one or more of a seat, a hip portion, a tummy portion, a thigh portion, a waist portion and combinations thereof of the garment. In these embodiment, the garment may provide at least one function selected from the group consisting of provide seat life, hip shaping, tummy flattening, thigh slandering, waist slimming, and combination thereof.

In one nonlimiting embodiment, the method is used to produce a shaping garment. In this method, a suitable stretch fabric is selected as the base fabric. The shaping zone is then designed where the elastic film with LMP is applied and offers shaping function with heavy-stretch characteristic. The film is then applied in an accurate and efficient manner and the base fabric for the shaping garment is pressed at a suitable temperature and time for firm fixation of the film with LMP to the base fabric.

Fabrics comprising APD with LMP in accordance with the present invention can be made with various stretch levels in different locations on a garment by applying different films. For example, a heat press process can be performed in certain areas to form stretch/recovery enhancement. When the film is applied onto certain pre-determined areas, the fabric has less stretch level but higher recovery power within the area and is referred to as a “shaping zone”. In such shaping zones, the fabrics have high stretch modulus and higher retract force, which limits the fabric deformation as compared to areas without shaping zones. As the human body moves, the garment can be strategically relocated to provide shaping effects during wearing. The portion of the human body surface to which the shaping zone is applied is subjected to a tightening force. Therefore a difference between the shaping zone and an area without a shaping zone results because of the pressure difference. Fabric in shaping zone may fit to the shape of the body contours and to smooth or control the display of some of the key areas. The shaping zone may thus be tailored to extend over only those regions where it is desired.

It will be appreciated that the shaping zone is not located all over the garment, so as to produce an allover squeeze but is provided in carefully selected areas. The results of the positioning of the shaping zone is to provide support and shaping to the contours of the body, slimming the thighs, lifting the buttocks and flattening the abdomen, thus creating an improved silhouette rather than simply constricting the entirely of the lower body.

In one nonlimiting embodiment, the tape or film of the present invention can be used in LYCRA® Fitsense applications which allow for the use of finer and technically more advanced fabrics called second skin. The objective of LYCRA® Fitsense is to reduce the number of seams in sports garments, while guaranteeing the support and comfort properties that are achieved with traditional corsetry garments. The tapes and films of the present invention are useful in achieving this objective.

The tapes and films of the present invention will help clothing producers reduce manufacturing costs, improve the fabric quality and the fit of the garment, in clothing such as, but not limited to, tops, leggings and lingerie.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

The following examples demonstrate the present invention and its capability for use in manufacturing a variety of films and tapes. The invention is capable of other and different embodiments, and its several details are capable of modification in various apparent respects, without departing from the scope and spirit of the present invention. Accordingly, the examples are to be regarded as illustrative and not as restrictive.

### EXAMPLES

Table o1 lists the materials and process conditions that were used to manufacture the film and tape samples with APD and LMP.

TABLE 1

| | Aqueous PU | Solid Low Melt | Ratio of | Blending | Application | | Thermal |
|---|---|---|---|---|---|---|---|
| | dispersion (APD) | Powder (LMP) | LPM:APD | Form | Method | Substrate | Function |
| Example 1 | F120 Prepolymer | | | | | | |
| Example 2 | F120 Dispersion | | | | | | |
| Example 3 | F40 Prepolymer | | | | | | |
| Example 4 | F40 Dispersion | | | | | | |
| Example 5 | F120 | Co-polyamide | 55% | Dispersion | | | |
| | | | | mixture | | | |
| Example 6 | F40 | Co-polyamide | 55% | Dispersion | | | |
| | | | | mixture | | | |
| Example 7 | F40 | Co-polyester | 52% | Dispersion | | | |
| | | | | mixture | | | |
| Example 8 | F120 | polyurethane | 55% | Dispersion | | | |
| | | | | mixture | | | |
| Example 9 | F120 | Co-polyamide | 55% | Dispersion | print | denim | Transfer |
| | | | | mixture | | | print |
| Example 10 | F40 | Co-polyamide | 55% | Dispersion | Pattern | Circular | Transfer |
| | | | | mixture | print | knit | print |
| Example 11 | F40 | Co-polyester | 55% | Dispersion | print | Circular | Transfer |
| | | | | mixture | | knit | print |
| Example 12 | F120 | Co-polyester | 53% | Dispersion | print | Bra | Transfer |
| | | | | mixture | | | print |
| Example 13 | F120 | Co-polyamide | 15% | Powder | Spread | T-shirt | Transfer |
| | | | | | | | print |
| Example 14 | F40 | Co-polyester | 16% | Powder | Spread | Whole | Transfer |
| | | | | | | WK | print |
| Example 15 | F40 | Co-polyester | 95% | Dispersion | print | Two | Transfer |
| | | | | mixture | | layers | print |
| Example 16 | F40 | Co-polyamide | 95% | Dispersion | print | Nylon | Transfer |
| | | | | mixture | | denim | print |
| Example 17 | F40 | PLA | 6% | Dispersion | Cast | | Breathable |
| | | | | mixture | | | porous |
| Example 18 | F120 | Polyolefins | 20% | Dispersion | Cast | | Breathable |
| | | | | mixture | | | porous |
| Example 19 | F40 | Polyethylene | 6% | Dispersion | Cast | | Breathable |
| | | | | mixture | | | porous |

In these examples, the following raw materials were used:

TABLE 2

| Ingredient | Chemical Name | CAS # | Tradename | Vendor |
|---|---|---|---|---|
| Glycol | PTMEG | 25190-06-1 | Terathane ® | The LYCRA |
| | | | 1800 | Company |
| Isocyanate | Dicyclohexylmethane | 5124-30-1 | Vestanate | Evonik |
| | diisocyanate | | H12MDI | |
| DMPA | Dimethylolpropionic | 4767-03-7 | D-MPA | GEO |
| | Acid | | | |
| Neutralizer | Triethylamine | 121-44-8 | TEA | BASF |
| Surfactant | Alkyldiphenyloxide | 119345-04-9 | Dowfax 2A1 | Dow |
| | Disulfonate | | | |
| Defoamer | mineral oil, silicone oil | Mixture | BYK 012 | BYK Additives & |
| | | | | Instruments |
| Antioxidant | hindered phenols | 36443-68-2 | Irganox 245 | BASF |
| Thickener | polyurethane | mixture | Tafigel PUR 61 | Munzing |

The following analytical methods were used in the Examples below where noted: 1) Titration methods; 2) Microwave methods; 3) Brookfield Viscosity, RV Spindle methods #3/10 rpm @ 25° C. The titration method used for determining the percent isocyanate (% NCO) of the capped glycol prepolymer was carried out according to the method of S. Siggia, “Quantitative Organic Analysis via Functional Group,” 3rd Ed., Wiley & Sons, New York, pages 559-561 (1963), using a potentiometric titration. The dispersion solid concentration was determined by a microwave solids analyzer LABWAVE 9000. The dispersion viscosity was determined with a Brookfield Viscometer.

### Example 1: Prepolymer Preparation for Aqueous Polyurethane Dispersion F120 without 1-Hexanol

A polyurethane prepolymer was made using a polytetramethylene ether glycol, an aliphatic diisocyanate such as PICM (4,4′-methylene bis (cyclohexyl isocyanate), a hydrogenated version of 4,4′-MDI) and a diol containing a sterically hindered carboxylic acid group. More specifically, the following ingredients and unit quantities were used to make the prepolymer:

TABLE 3

| Ingredient | CAS Number | Unit Quantity |
|---|---|---|
| Terathane* 1800 | 251090-06-1 | 72.7806 |
| 1-Hexanol | 111-27-3 | 0.0000 |
| Vestanat* H12MDI | 5124-30-1 | 24.7380 |
| DMPA | 4767-03-7 | 2.4814 |

| | |
|---|---|
| Prepolymer total | 100.0000 |

The reaction to prepare the prepolymer was carried out in a moisture-free, nitrogen-blanketed atmosphere to avoid side reactions. In this example, a 30 gallon reactor, jacketed with hot water and equipped with an agitator, was used. This reactor was heated to a temperature of about 55° C. A pre-determined weight of molten Terathane® 1800 glycol was charged into the reactor. Then, DMPA solid powder was added to the reactor with agitation and circulation, under nitrogen blanket, until the DMPA solid particles were dispersed and dissolved in glycol.

Molten PICM was then charged into the reactor with continuous agitation and the capping reaction was allowed to take place at 90° C. for 240 minutes, still with continuous agitation. The formed viscous prepolymer was then sampled to determine the extent of the reaction by measuring the weight percentage of the isocyanate groups (% NCO) of the prepolymer through a titration method. The theoretical value of the % NCO after the reaction is completed is 2.97 assuming the glycol MW is at 1800. If the determined % NCO value is higher than the theoretical value, the reaction should be allowed to continue until the theoretical value is reached or the % NCO number becomes constant. Once it was determined that the reaction is complete, the prepolymer temperature was maintained between 85 and 90° C.

### Example 2: Preparation of Aqueous Polyurethane Dispersion F120 with Prepolymer of Example 1

The aqueous polyurethane dispersion was prepared by the addition of the prepolymer of Example 1 using a rotor/stator high speed disperser. The prepolymer as made in Example 1 was transferred directly into the disperser head and dispersed under high shear forces into deionized water, containing a surfactant, a neutralizer, an anti-oxidant and a foam control agent. Slightly more prepolymer than required by the dispersion recipe was needed to compensate for loss in the transfer line and in the reactor.

The ingredients for making the dispersion and the composition of the aqueous polyurethane dispersion are shown below in Table 4.

TABLE 4

| Ingredient | CAS Number | Unit Quantity |
|---|---|---|
| Terathane* 1800 | 251090-06-1 | 30.1391 |
| Vestanat* H12MDI | 5124-30-1 | 10.2442 |
| DMPA | 4767-03-7 | 1.0276 |
| 1-Hexanol | 111-27-3 | 0.0000 |
| DI Water | 7732-18-5 | 54.8093 |
| Dowfax 2A1 | 119345-04-9 | 1.2652 |
| Triethylamine | 121-44-8 | 0.7830 |
| Irganox 245 | 36443-68-2 | 0.6051 |
| Tafigel PUR 61 | Mixture | 1.0000 |
| BYK 012 | Mixture | 0.1265 |
| Other | | 0.0000 |

| | |
|---|---|
| Total | 100.0000 |

In making a typical batch of 100 kg of the aqueous polyurethane dispersion, Dowfax 2A1 surfactant (1.2652 kg), an anti-oxidizer Irganox 245 (0.6051 kg), and foam control agent BYK-012 (0.1265 kg) were mixed and dissolved in the deionized water (54.8093 kg). The triethylamine neutralizer (0.783 kg) was added to the above water mixture 5 minutes prior to the addition of the prepolymer. The prepolymer (41.4109 kg) maintained at a temperature between 85 and 90° C. was added into the water mixture with high speed dispersing. The addition rate (typically at about 1.5 kg/min or about 30 minutes) of the prepolymer should be controlled to allow the formation of uniform dispersion, and the temperature of the dispersion should be kept between 40 and 45° C. Once the addition of prepolymer was complete, mixing was continued for 60 minutes. Then, a thickener Tafigel PUR 61 (1.00 kg) was added and allowed to mix for another 60 minutes. The as-made dispersion was continuously agitated at low speed for 8 hours (or overnight) in the container to eliminate foams and to ensure the reaction had reached completion. The finished dispersion typically contains about 42% solids, with viscosity about 4000 centipoises and pH in the range of 7.0 to 8.5.

The dispersion was then filtered through 100 micron bag filters to remove big particles before packed for shipment. It is recommended to use 55 gallon metal drums with polyethylene liner inside to contain the dispersion for shipment.

Final product specifications were determined as shown in Table 5.

TABLE 5

| Parameters | Aim | ± Limits | Method |
|---|---|---|---|
| Prepolymer % NCO* | 3.00 | 0.10 | Titration |
| Dispersion Solids, % | 44.0 | 2.0 | Microwave |
| Dispersion Viscosity, cps** | 4000 | 1000 | RV Spindle #3/ |
| | | | 10 rpm@25° C. |
| Dispersion pH | 7.7 | 0.7 | |

| | |
|---|---|
| Dispersion Filterability | Passing through filter bags no more |
| | than 100 microns |

*Sampled 20-30 minutes before the prepolymer is dispersed.
**Sampled and measured 24 hours after the dispersion is thickened.

### Example 3: Preparation of Prepolymer for Aqueous Polyurethane Dispersion F40 with 1-Hexanol

The polyurethane prepolymer was made using a polytetramethylene ether glycol, 1-Hexanol, an aliphatic diisocyanate such as PICM (4,4′-methylene bis (cyclohexyl isocyanate), a hydrogenated version of 4,4′-MDI) and a diol containing a sterically hindered carboxylic acid group. Table 6 lists the ingredients and unit quantities used to make the prepolymer.

TABLE 6

| Ingredient | CAS Number | Unit Quantity |
|---|---|---|
| Terathane* 1800 | 251090-06-1 | 72.4492 |
| 1-Hexanol | 111-27-3 | 0.4087 |
| Vestanat* H12MDI | 5124-30-1 | 24.6607 |
| DMPA | 4767-03-7 | 2.4814 |

| | |
|---|---|
| Prepolymer total | 100.0000 |

The reaction to prepare the prepolymer was carried out in a moisture-free, nitrogen-blanketed atmosphere to avoid side reactions.

In this example, a 30 gallon reactor, jacketed with hot water and equipped with an agitator, was used. This reactor was heated to a temperature of about 55° C. A pre-determined weight of molten Terathane® 1800 glycol was charged into the reactor. The 1-Hexanol was added second. Then, DMPA solid powder was added to the reactor with agitation and circulation, under nitrogen blanket, until the DMPA solid particles were dispersed and dissolved in glycol.

Molten PICM was then charged into the reactor with continuous agitation and the capping reaction was allowed to take place at 90° C. for 240 minutes, still with continuous agitation. The formed viscous prepolymer was then sampled to determine the extent of the reaction by measuring the weight percentage of the isocyanate groups (% NCO) of the prepolymer through a titration method. The theoretical value of the % NCO after the reaction is completed is 2.80 assuming the glycol MW is at 1800. If the determined % NCO value is higher than the theoretical value, the reaction should be allowed to continue until the theoretical value is reached or the % NCO number becomes constant. Once it was determined that the reaction is complete, the prepolymer temperature was maintained between 85 and 90° C.

### Example 4: Preparation of Aqueous Polyurethane Dispersion F40 with Prepolymer of Example 3

The aqueous polyurethane dispersion was prepared by the addition of prepolymer of Example 3 using a rotor/stator high speed disperser. The prepolymer as made in Example 3 was transferred directly into the disperser head and dispersed under high shear forces into deionized water, containing a surfactant, a neutralizer, an anti-oxidant and a foam control agent. Slightly more prepolymer than required by the dispersion recipe is needed to compensate for loss in the transfer line and in the reactor.

Table 7 lists the ingredients used in making the aqueous polyurethane dispersion and the composition of the aqueous polyurethane dispersion.

TABLE 7

| Ingredient | CAS Number | Unit Quantity |
|---|---|---|
| Terathane* 1800 | 251090-06-1 | 30.0000 |
| Vestanat* H12MDI | 5124-30-1 | 10.2116 |
| DMPA | 4767-03-7 | 1.0275 |
| 1-Hexanol | 111-27-3 | 0.1692 |
| DI Water | 7732-18-5 | 54.8083 |
| Dowfax 2A1 | 119345-04-9 | 1.2652 |
| Triethyl amine | 121-44-8 | 0.7866 |
| Irganox 245 | 36443-68-2 | 0.6051 |
| Tafigel PUR 61 | Mixture | 1.0000 |
| BYK 012 | Mixture | 0.1265 |
| Other | | 0.0000 |
| Total | | 100.0000 |

In making a typical batch of this 100 kg dispersion Dowfax 2A1 surfactant (1.2652 kg), an anti-oxidizer Irganox 245 (0.6051 kg), and foam control agent BYK-012 (0.1265 kg) were mixed and dissolved in the deionized water (54.8083 kg). The triethylamine neutralizer (0.7866 kg) was added to the above water mixture 5 minutes prior to the addition of the prepolymer. The prepolymer (41.4083 kg) maintained at a temperature between 85 and 90° C. was added into the water mixture with high speed dispersing. The addition rate (typically at about 1.5 kg/min or about 30 minutes) of the prepolymer should be controlled to allow the formation of uniform dispersion, and the temperature of the dispersion should be kept between 40 and 45° C. Once the addition of prepolymer was complete, mixing was continued for 60 minutes. Then, a thickener Tafigel PUR 61 (1.00 kg) was added and allowed to mix for another 60 minutes. The as-made dispersion was continuously agitated at low speed for 8 hours (or overnight) in the container to eliminate foams and to ensure the reaction had reached completion. The finished dispersion typically contains about 42% solids, with viscosity about 4000 centipoises and pH in the range of 7.0 to 8.5.

The dispersion is then filtered through 100 micron bag filters to remove big particles before packed for shipment. It is recommended to use 55 gallon metal drums with vented caps, and with a polyethylene liner inside to contain the dispersion for shipment.

Final product specifications were determined as shown in Table 8.

TABLE 8

| Parameters | Aim | ± Limits | Method |
|---|---|---|---|
| Prepolymer % NCO* | 2.80 | 0.10 | Titration |
| Dispersion Solids, % | 44.0 | 2.0 | Microwave |
| Dispersion Viscosity, cps** | 4000 | 1000 | RV Spindle #3/ |
| | | | 10 rpm@25° C. |
| Dispersion pH | 7.7 | 0.7 | |

| | |
|---|---|
| Dispersion Filterability | Passing through filter bags no more |
| | than 100 microns |

*Sampled 20-30 minutes before the prepolymer is dispersed
**Sampled and measured 24 hours after the dispersion is thickened.

### Example 5: APD F120 with Copolyimide LMD

F120 aqueous polyurethane described in Example 2 is mixed with polyamide copolymer low melt powder. The content weight percentage of low melt powder is 55% of total mixed weight of aqueous polyurethane dispersion and low melt powder. The low meld powder is Co-Polyamide PA, GrilTEX D 1500A P 1 Transfer Adhesion Powder, made by EMS-Gril Tech CH-7013 Domat/EMS, Switzer Land, with melt temperature 135° C. and particular size around 1 micron.

After stirring them together evenly at room temperature, wet dispersion mixture is made and ready to be used. The dispersion mixture is poured onto a release paper and a metal knit blade is used to cast the dispersion mixture into uniform thickness by spreading it across the release paper. The paper with dispersion is then dried at 90° C. to remove the water and form the film. The formed film sheet which has 1 um thickness, is cut into strips. Through heat transfer process, the film strip is bond with a circular knit fabric at about 150° in a period of 25 seconds under middle lever pressure. The bonding is strong and durable when exposed to repeated wear, wash, and stretch with the knit fabric. The binding area and fabric have very high stretch modulus and recovery force.

### Example 6: APD F40 with Copolyimide LMD

F40 Aqueous polyurethane described in Example 4 is mixed with polyamide copolymer low melt powder. The content weight percentage of low melt powder is 55% of total mixed weight of aqueous polyurethane dispersion and low melt powder. The low melt powder is Co-Polyamide PA, GrilTEX D 1500A P 1 Transfer Adhesion Powder, made by EMS-Gril Tech CH-7013 Domat/EMS, Switzer Land, with melt temperature 135° C. and particular size around 1 micron.

The film is made in the same manner as Example 6, except the APD is F40 instead of F120. The bonding is strong and durable when exposed to repeated wear, wash, and stretch with the knit fabric. The binding area and the fabric have very high stretch modulus and recovery force. As compared with Example 5, this film has soft hand and binding ability but the elastic recovery power is weaker than F120 in Example 5.

### Example 7: APD F40 with Co-Polyester LMD

F40 aqueous polyurethane described in Example 4 is mixed with polyester copolymer low melt powder. The content weight percentage of low melt powder is 52% of total mixed weight of aqueous polyurethane dispersion and low melt powder. LMP: Co-polyester, 700 Heat Transfer adhesive, under White Stuff® brand, made by Cyberbond LLC, Batavia, Ill. 60510. Melt temperature 150° C.

After stirring them together evenly at room temperature, wet dispersion mixture is made and ready to be used. The dispersion mixture is poured onto a release paper and a metal knit blade is used to cast the dispersion mixture into uniform thickness by spreading it across the release paper. The release paper with dispersion are then dried at 90° C. to remove the water and form the film. The formed film sheet which has 1 um thickness, is cut into strips. Through heat transfer process, the film strip is bond with a circular knit fabric at about 150° in a period of 25 seconds under middle lever pressure. The bonding is strong and durable when exposed to repeated wear, wash, and stretch with the knit fabric. The binding area and the fabric have very high stretch modulus and recovery force.

### Example 8: APD F120 Aqueous PU Dispersion with Thermal Plastic LMD

F120 aqueous polyurethane described in Example 2 is mixed with plastic PU low melt powder. The content weight percentage of low melt powder is 55% of total mixed weight of aqueous polyurethane dispersion and low melt powder. The low melt powder is Polyurethane base, C-56 Transfer Adhesive powder, made by Lancer Group International, 311 Saulteax Crescent, Winnipeg, Manitoba, Canada., Melt temperature 150° C.

After stirring them together evenly at room temperature, wet dispersion mixture is made and ready to be used. The dispersion mixture is poured onto a release paper and a metal knit blade is used to cast the dispersion mixture into uniform thickness by spreading it across the release paper. The release paper with dispersion is then dried at 90° C. to remove the water and form the film. The formed film sheet which has 1 um thickness, is cut into strips. Through heat transfer process, the film strip is bond with a circular knit fabric at about 150° in a period of 25 seconds under middle lever pressure. The bonding is strong and durable when exposed to repeated wear, wash, and stretch with the knit fabric. The binding area and the fabric have very high stretch modulus and recovery force.

### Example 9: APD F120 Dispersion Composite with Thermal Plastic LMD

100% of F120 aqueous polyurethane dispersion described in Example 2 was poured onto a release paper. Then a metal knit blade is used to cast the dispersion into uniform thickness by spreading it across the release paper. The release paper with dispersions is then dried in at 90° C. to remove the water and form the film. The formed film sheet has 1 um thickness.

The surface of this dried film was printed with the wet dispersion mixture of F120 and Co-Polyamide PA, GrilTEX D 1500A P 1 Transfer Adhesion Powder, as described in Example 5. After drying at 90° C., the film and wet dispersion combine together to form a dispersion composition. As compared with example 5, this dispersion composite has much high modulus and retract power, while it still has a bonding ability in the surface of the film.

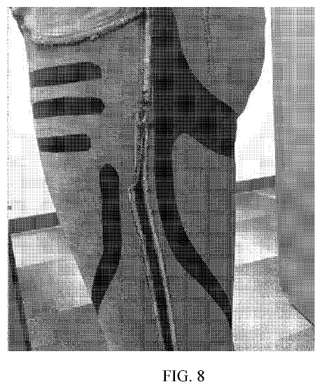

As show in FIG. 8, the dispersion composite is cut into strips and bonded to jeans through a heat press. The garment bond with dispersion composite is used for shaping function in the butt-shaping zone, arranged around the buttock area and thigh area. The bonding is strong and durable when exposed to repeated wear, wash, and stretch. In the shaping area, the fabric has very high stretch modulus and recovery force.

### Example 10: APD F40 Dispersion Composite with Co-Polyamide LMD

100% of F40 aqueous polyurethane dispersion described in Example 4 was printed onto a release paper with #120 mesh screen print in two strokes. The print design is a geometrical configuration of intersecting diagonal lines with diamond-shaped voids between the lines. The F40 dispersion is printed in the lines across the release paper. Dry in at 90° C. to remove the water and form the design.

On the surface of the dry design, a layer of wet dispersion mixture of F40 and Co-Polyamide PA, GrilTEX D 1500A P 1 Transfer Adhesion Powder as described in Example 6, was printed on through anther screen print process. After drying at 90° C., the design and wet dispersion print combines to form a dispersion composite. By using normal heat pressing at 150° C. for 20 seconds, the dispersion composite binds well with a stretch circular knit fabric with Nylon and spandex.

### Example 11: APD F40 Dispersion Composite with Thermal Plastic LMD

100% of F40 aqueous polyurethane dispersion described in Example 4 was poured onto a release paper. Then a metal knit blade is used to cast the dispersion into uniform thickness by spreading it across the release paper. The release paper with dispersion is dried at 90° C. to remove the water and form the film. The formed film sheet has 1 um thickness.

The surface of this dried film was printed with the wet dispersion mixture of F40 and Co-polyester, 700 Heat Transfer adhesive, under White Stuff® brand, as described in Example 7. After drying at 90° C., the film and wet dispersion combine to form a dispersion composition. As compared with example 7, this dispersion composite has much high modulus and retract power, while it still has a bonding ability in the surface of the film.

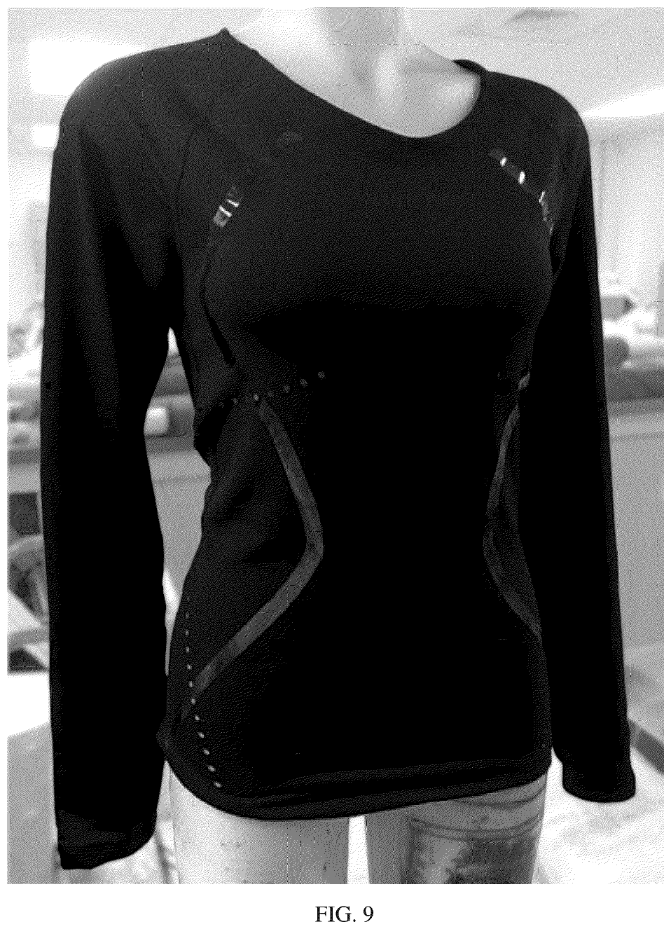

As show in FIG. 9, the dispersion composite is cut into strips and bonded with a nylon active wear shirt through heat press. The garment bond with dispersion composite for shaping function was applied to two front sides of the shirt. The bonding is strong and durable when exposed to repeated wear, wash, and stretch. In the shaping area, the fabric has very high stretch modulus and recovery force.

### Example 12: APD F120 Dispersion Composite for Bra

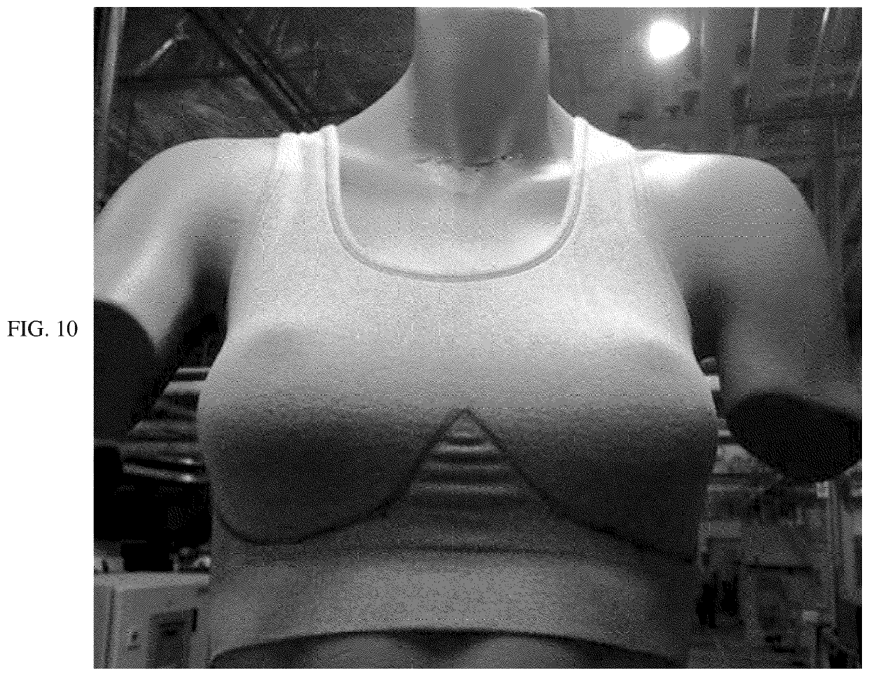

The dispersion composite was made in the way as described in example 9. The film is cut into a curved stripe and bonded with a top under bra. The heat press condition is 150° C. for 20 seconds under 2 psi pressure. The stripe firmly sticks with the fabric and could stand 30 times washes. The elasticity and recovery force of the stripe offer the shaping and support function to the bra as shown in FIG. 10.

### Example 13: APD F120 Dispersion Composite by Spreading LMP

100% of F120 aqueous polyurethane dispersion described in Example 2 was poured onto a release paper. Then a metal knit blade is used to cast the dispersion into uniform thickness by spreading it across the release paper. Before dispersion film dries, solid low melt Co-Polyamide powder, GrilTEX D 1500A P 1 Transfer Adhesion Powder, is spread on the top of wet film. Then, the dispersion film with powder is dried at 90° C. to remove the water and form the film. The formed film sheet has 1.2 mil thickness.

The surface of this dried film was printed with the wet dispersion mixture of F120 and Co-Polyamide PA, GrilTEX D 1500A P 1 Transfer Adhesion Powder, as described in Example 5. After drying at 90° C., the film and wet dispersion combine together to form a dispersion composition. As compared with example 5, this dispersion composite has much higher modulus and retract power, while it still has a bonding ability in the surface of the film.

As compared with the dispersion composite in Example 9, this film has similar bind ability and recovery power. But the manufacture of this film is easier and eliminates the second time of screen process.

### Example 14: APD F40 Dispersion Composite by Spreading Co-Polyester LMP

100% of F40 aqueous polyurethane dispersion described in Example 4 was printed onto a release paper with #120 mesh screen print in two strokes. The print design is a geometrical configuration of intersecting diagonal lines with diamond-shaped voids between the lines. The F40 dispersion is printed in the lines across the release paper; the release paper is then dipped into the low melt powder (Co-polyester, 700 Heat Transfer adhesive, under White Stuff® brand) and the paper is tilted to cover all the dispersion. Excess LMP is then shaken off and the transfer print is placed onto oven belt at temperature 90° C. When the transfer comes out of the oven, it is ready to be used or stored.

The transfer print is placed on the top of a stretch warp knit fabric. Because the contact side of the transfer print with the fabric possesses low melt powder, the transfer print and the fabric bind together very well after heat pressing process.

### Example 15: APD F40 with High Content Co-Polyester LMD

F40 aqueous polyurethane described in Example 4 is mixed with polyester copolymer low melt powder. The content weight percentage of low melt powder is 95% of total mixed weight of aqueous polyurethane dispersion and low melt powder. LMP: Co-polyester, 700 Heat Transfer adhesive, under White Stuff® brand, made by Cyberbond LLC, Batavia, Ill. 60510. Melt temperature 150° C.

After stirring these two chemicals with water together evenly at room temperature, wet dispersion mixture is made and ready to be used. A small amount of thickener is also used to adjust the viscosity of the mixture. The dispersion mixture is poured onto a release paper and a metal knit blade is used to cast the dispersion mixture into uniform thickness by spreading it across the release paper. The release paper with dispersion is dried at 90° C. to remove the water and form the film. The formed film sheet which has 1 um thickness, is cut into strips.

Through heat transfer process, the film strip is bonded with a polyester circular knit fabric at about 150° C. in a period of 25 seconds under middle level pressure. The release paper is removed and another layer of nylon circular fabric is placed on the top of the film strip. They are then bonded together again in heat pressing machine under 150° C. in a period of 25 seconds. In this way, two pieces of fabric, polyester knit and nylon knit fabrics adhere together. The dispersion filament acts as a binding agent in the center between two fabrics. The bonding is strong and durable when exposed to repeated wear and wash.

### Example 16: APD F40 with High Content Co-Polyamide LMD

F40 aqueous polyurethane described in Example 4 is mixed with polyester copolymer low melt powder. The content weight percentage of low melt powder is 95% of total mixed weight of aqueous polyurethane dispersion and low melt powder. The low melt powder is Co-Polyamide PA, GrilTEX D 1500A P 1 Transfer Adhesion Powder, made by EMS-Gril Tech CH-7013 Domat/EMS, Switzer Land, with melt temperature 135° C. and particular size around 1 micron.

After stirring these two chemicals with water together evenly at room temperature, a wet dispersion mixture is made and ready to be used. A small amount of thickener is also used to adjust the viscosity of the mixture. The dispersion mixture is printed onto the back of a nylon stretch warp knit fabric through screen print. Another layer of stretch denim fabric is placed on the top the nylon fabric. They are bonded together in a heat pressing machine under 150° C. in a period of 25 seconds. In this way, two pieces of fabric, nylon warp stretch knit and stretch denim fabrics adhere together. The dispersion filament acts as a binding agent in the center between two fabrics. The bonding is strong and durable when exposed to repeated wear and wash.

### Example 17: APD F40 with PLA LMD

F40 aqueous polyurethane described in Example 4 is mixed with PLA low melt powder. The content weight percentage of low melt powder is 6% of total mixed weight of aqueous polyurethane dispersion and low melt powder. The low melt powder is Polylactic Acid, X-1718 W65648Am, wax powder made from a biodegradable polymer from renewable resource, made by Micro Powders Inc, 580 White Plains Road, Tarrytown, N.Y. 10591, with melt temperature 140° C.-150° C. and particular size 16-20 micron, maximum 74 microns.

After stirring them together evenly at room temperature, wet dispersion mixture is made and ready to be used. The dispersion mixture is poured onto a release paper and a metal knit blade is used to cast the dispersion mixture into uniform thickness by spreading it across the release paper. The release paper with dispersion is dried at 90° C. to remove the water and form the film. The formed film sheet was processed again in a heat press machine at about 150° in a period of 25 seconds under middle lever pressure. After stretching the film out about 10% in width direction, a mixture of micro pores can be seen clearly. During heat pressing process, the polylactic acid low melt powder melts away and empty pores form in the film. These pores increase the air permeability to allow hot air through. However, the pore size is small enough to stop the water drops from penetrating through the fabrics.

### Example 18: APD F120 with Polyolefins

F120 aqueous polyurethane described in Example 4 is mixed with PLA low melt powder. The content weight percentage of low melt powder is 20% of total mixed weight of aqueous polyurethane dispersion and low melt powder. The low melt powder is Polyolefins, Aquamatte 22 wax powder with high density oxidized, made by Micro Powders Inc, 580 White Plains Road, Tarrytown, N.Y. 10591, with melt temperature 135° C.-140° C. and particular size 6.0-8.0 micron.

After the same process as Example 17, the film of F120 has various micro pores after stretching out. As compared with Example 17, this film is more porous due to higher content of low melt powder, which brings better air breath ability of the film, but weaker strength and lower break elongation.

### Example 19: APD F40 with Polyethylene LMD

F40 aqueous polyurethane described in Example 4 is mixed with polyethylene low melt powder. The content weight percentage of low melt powder is 6% of total mixed weight of aqueous polyurethane dispersion and low melt powder. The low melt powder is Polyethylene, MPP-635XF wax powder, made by Micro Powders Inc, 580 White Plains Road, Tarrytown, N.Y. 10591, with melt temperature 125° C. and particular size 4.0-6.0 micron.

After stirring them together evenly at room temperature, wet dispersion mixture is made and ready to be used. The dispersion mixture is poured onto a release paper and a metal knit blade is used to cast the dispersion mixture into uniform thickness by spreading it across the release paper. The release paper with dispersion is dried at 90° C. to remove the water and form the film. The formed film sheet was processed again in a heat press machine at about 150° in a period of 25 seconds under middle lever pressure. After stretching the film out about 10% in width direction, a mixture of micro pores can be seen clearly. During heat pressing process, the polylactic acid low melt powder melts away and leaves empty pores in the film. These pores increase the air permeability to allow hot air through. However, the pore size is small enough to stop the water drops to penetrate through the fabrics.

1: An elastic tape or film with a first and second side, said elastic tape or film comprising an aqueous polyurethane dispersion and a solid low melt powder with a melt temperature between about 80° C. and 190° C., wherein content weight percentage of low melt powder versus weight of the aqueous polyurethane dispersion is between 1% to 95%.

2: The elastic tape or film of claim 1 which is applicable to a fabric via thermal transfer printing.

3: The elastic tape or film of claim 1 which is porous.

4: The elastic tape or film of claim 1 wherein the aqueous polyurethane dispersion is solvent free.

5: The elastic tape or film of claim 1 wherein the solid low melt powder is located or concentrated in the first side of the film or tape.

6: The elastic tape or film of claim 1 wherein the solid low melt powder is located or concentrated in the first and second sides of the film or tape.

7: The elastic tape or film of claim 1 wherein the solid low melt powder is selected from the group consisting of polyester, co-polyester, polyethylene, polyolefin, polyamide, copolyimide, polyurethane, ethylene-vinyl acetate and polylactic acid (PLA).

8: An elastic dispersion composite comprising a stretchable substrate and an elastic tape or film of claim 1.

9: The elastic dispersion composite of claim 8 wherein the elastic substrate is an elastic fabric.

10: The elastic dispersion composite of claim 9 wherein the elastic fabric is selected from the group consisting of woven, circular knit, warp knit, nonwoven fabrics and the combinations thereof.

11: The elastic dispersion composite of claim 9 wherein the elastic fabric comprise spandex fiber.

12: The elastic dispersion composite of claim 9 wherein the elastic fabric comprises polyester bi-component fiber.

13: A garment comprising at least one area with an elastic dispersion composite of claim 8.

14: The garment of claim 13, wherein said garment is selected from the group consisting of active wear, sportswear, professional apparel, intimate apparel, pants, denim jeans and ready to wear.

15: The garment of claim 13, wherein the elastic dispersion composite corresponds to a seat, a hip portion, a tummy portion, a thigh portion, a waist portion and combinations thereof of the garment.

16: The garment of claim 13, wherein the garment provides at least one function selected from the group consisting of provide seat life, hip shaping, tummy flattening, thigh slandering, waist slimming, and combination thereof.

17: A method for producing the elastic tape or film of claim 1, said method comprising evenly distributing a solid low melt powder in an aqueous polymer dispersion through a powder spread or powder mixture print.

18: A method for production of the garment of claim 13 wherein an elastic tape or file comprising a polymer dispersion and a solid low melt powder is applied to the garment via transfer printing.
